(19) United States
(12) Patent Application Publication
(10) Pub. No.: US 2012/0004983 A1
(43) Pub. Date: Jan. 5, 2012

(54) SYSTEMS AND METHODS FOR DETERMINING THE EFFICACY OF ADVERTISING

(75) Inventors: Sara Borthwick, San Francisco, CA (US); Anne Claudio, San Francisco, CA (US)

(73) Assignee: CBS Interactive Inc., San Francisco, CA (US)

(21) Appl. No.: 12/899,243

(22) Filed: Oct. 6, 2010

Related U.S. Application Data
(60) Provisional application No. 61/360,402, filed on Jun. 30, 2010.

(51) Int. Cl. G06Q 30/00

(52) U.S. Cl. 705/14.45; 705/14.41

(57) ABSTRACT

A computer-implemented method for determining effectiveness of content includes receiving, by a computing device, a plurality of attributes relating to rendered content, the plurality of attributes including at least one attribute that characterizes a consumer response to the rendered content and at least one attribute that characterizes a creative strength of the rendered content, generating, by a computing device, an index score indicative of an effectiveness of the content using a statistical analysis of the collected attributes, and storing the index score in memory.

### PRIORITY CLAIM

This application claims the benefit of U.S. Provisional Application No. 61/360,402, filed Jun. 30, 2010, the disclosure of which is incorporated herein by reference in its entirety.

### BACKGROUND

The subject invention relates to systems and methods for determining the efficacy of content, such as advertising displayed on a display device.

People use the internet to shop, to socialize, to play games and for many other entertainment activities. People also use the internet to search for and research products and often discuss products on blogs and social networks. Advertisers target these same people with online advertisements. In the past, these advertisements have been static images, but, more recently, advertisers have also adopted video advertising to deliver marketing campaigns.

To determine the effectiveness of advertisements, advertisers typically survey consumers to determine their responses to these advertisements, for example television advertisements, and identify the audience demographic reached with the advertising campaign (using Nielsen ratings, for example). However, surveys and identification of audience demographics fail to provide a complete analysis of the effectiveness of the advertising campaigns. Further, such techniques do not work well for content displayed in an online computer network.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram of an exemplary network architecture.

FIG. 2 is a block diagram of a system for determining efficacy of an advertisement.

FIG. 3 is a detailed block diagram of a system for determining efficacy of an advertisement.

FIG. 4 is a flow diagram of a process for determining efficacy of an advertisement.

FIGS. 5A and 5B are schematic diagrams of categories of attributes useful for determining efficacy of an advertisement.

FIGS. 6A-6C are schematic diagrams of attribute types useful for determining efficacy of an advertisement.

FIG. 7 is a schematic diagram of an exemplary report showing efficacy of an advertisement.

FIG. 8 is a block diagram of an exemplary computer system useful for performing a process for determining efficacy of an advertisement.

### DETAILED DESCRIPTION OF EMBODIMENTS

Embodiments disclose systems and methods for determining the effectiveness of content, such as advertising campaigns. In some embodiments, systems and methods determine the effectiveness of one or more online video advertising campaigns. Of course, embodiments may also determine the effectiveness of other types of advertising campaigns (e.g., television/broadcast advertising, print advertising, mobile advertising, online television advertising, or combinations of types of advertising). The embodiments can be applied to advertisements or other content.

Disclosed embodiments provide systems and methods for understanding the profile of an audience that has been exposed to content and for understanding how that audience profile responds to the content they were exposed to. For example, the audience exposed to an advertisement or an advertisement campaign may be profiled based on characteristics such as household income, geographic location, education level, number of children in the home, or any other demographic features. Embodiments may then determine how that audience responds to an advertisement or advertisement campaign (e.g., who is purchasing products or otherwise giving positive feedback to the advertisement). By gathering information about who is responding to the advertisement, advertisement campaigns may be optimized, for example to better reach that specific audience or to provide feedback to the advertiser that the creative message did not positively affect the target audience. Embodiments can also be used to establish pricing tiers, or other pricing models, for content. Further, advertisers may partner with other entities, for example entities that aggregate and track user data online, such as BLUEKAI, to supplement audience profile information.

Audience profiling and targeting, thus, can provide a basis for predicting a return on investment (“ROI”) of an advertising campaign. This can in turn help advertisers be more accountable and allow marketers to better understand how the money they spend generates revenue. Thus, embodiments can assist marketers to determine the effectiveness of advertising as opposed to other marketing tools (e.g., in store promotions, couponing, etc.). Embodiments can help a marketer determine whether a given product is a product that should be promoted to a large audience (i.e., advertised) and whether advertising is an effective component of the marketing and promotional scheme. If it is predicted that advertising would be affective, embodiments can help a marketer determine what types of advertising should be done (e.g., the creative message for the advertising, the target audience, the size of an advertising campaign, etc.) and the specific media placements for the advertising.

Systems and methods may generate an index score weighing multiple campaign variables, cross-platform, to assist marketers in making strong business decisions and to drive non-endemic revenue. The index score can be generated using statistical analysis, by way of example only, regression analysis, cluster analysis, and/or colinearity analysis. The systems and methods can provide comprehensive feedback to advertisers based on action against objectives (e.g., exposed versus not exposed, sales (in-store and/or online), leads, time spent, etc.), consumer behavior (e.g., click thru rates, video consumption, click pathways, etc.), target consumer profile (e.g., user profile, demographics, etc.), creative testing (e.g., measurement of user response to creative messages, both subconscious (neuro-research) and conscious), consumer attitudes (e.g., consumer buzz, user generated content, etc.), creative strength (e.g., ad effectiveness), and the like. The score is a metric that normalizes various campaign variables. The score can be used to drive incremental revenue and can be used to determine the value and effectiveness of various types of advertising campaigns. Reports can also be generated that discuss the score and methodologies for improving the score. Similarly, reports that compare the advertising campaign to other advertising campaigns or to the industry may also be generated.

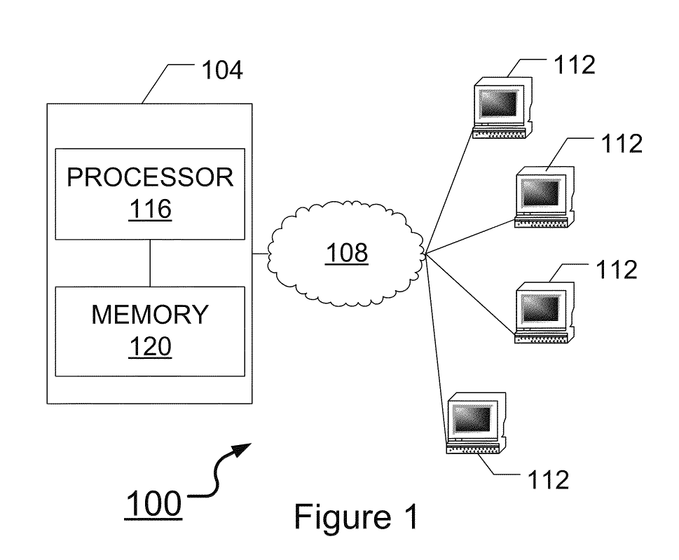

FIG. 1 illustrates a web-based system 100 for delivering content to a user. System 100 includes a host site 104 and a plurality of user systems 112, i.e., computing devices, coupled via a network 108. Host site 104 includes a processor 116 and memory 120.

Host site 104 may be operatively coupled to user systems 112 over network 108. Processor 116 is in communication with memory 120. Host site 104 is typically a computer system, and may be a Hypertext Transfer Protocol (“HTTP”) server (e.g., an Apache server). Memory 120 includes storage media, which may be volatile or non-volatile memory that includes, for example, read only memory (“ROM”), random access memory (“RAM”), magnetic disk storage media, optical storage media, flash memory devices, and zip drives.

Network 108 may be a local area network (“LAN”), wide area network (“WAN”), an intranet, the Internet, combinations thereof, or any other type of network. User systems 112 may be mainframes, minicomputers, personal computers, laptops, personal digital assistants (“PDA”), cell phones, thin devices, set top boxes, and the like. User systems 112 are characterized in that they are capable of being operatively coupled to network 108. User systems 112 typically include web browsers.

When a user of one of user systems 112 requests to access or view a webpage, user system 112 communicates a request to host site 104 over network 108. For example, a signal may be transmitted from one of user systems 112, the signal having a destination address (e.g., address representing the destination of the requested page), a request (e.g., a request to view the requested page) and a return address (e.g., address representing user system that initiated the request). The request may include one or more cookies, for example including data identifying the user and/or the user system 112. Processor 116 accesses memory 120, for example a database (e.g., a relational database or a flat database) stored on memory 120, to provide the user with the requested webpage, which is communicated to the user over network 108. Another signal may be transmitted that includes a destination address corresponding to the return address of the user system 112 and a webpage responsive to the request. Processor 116 may also collect user data, for example using logfile analysis, page tagging, click analytics, and the like.

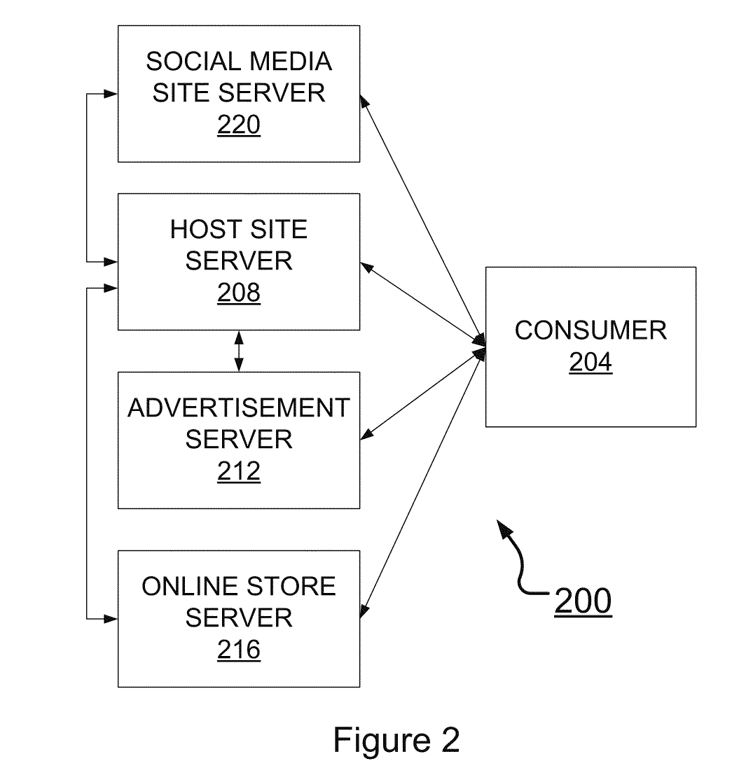

FIG. 2 illustrates an exemplary computer system 200 that delivers advertisements, for example video advertisements, to consumers and tracks consumer responses to the advertisements. A consumer 204 at a client device may view a webpage from a host site server 208 as described above with reference to FIG. 1. Host site server 208 may interact with an advertisement server 212 to deliver an advertisement to the consumer 204 with (e.g., embedded in) the webpage delivered by the host site server 208. Methods for delivering advertisements, including video advertisements, to consumers are well-known. Of course, while consumer 204 is described as a “consumer”, one of ordinary skill in the art understands that a “consumer” referred to herein need not purchase a product advertised in an advertisement, rather a consumer may be any person who perceives content or has content rendered to them as part of a webpage. Advertisements can be rendered in any manner, for example displayed or, in the case of audio or video streams, played. As an example, advertisements can be compliant with Ad Unit Guidelines promulgated by the Interactive Advertising Bureau (“IAB”).

Consumer 204 (i.e., a user) may then view the advertisement displayed on the webpage. In some embodiments, an audio or video advertisement may play (i.e., be rendered) automatically, while, in other embodiments, the consumer may interact with (e.g., click on) the audio or video advertisement to play it. Host site server 208 may track data relating to a consumer's perception and interaction with an advertisement, for example whether the consumer is on the page long enough to view an entire video advertisement, whether the consumer clicks on the advertisement, whether the consumer mouses over the advertisement, whether the user “scrubs” the advertisement (i.e., moves the scroll bar so that the advertisement is shown in the consumer's viewable window), etc.

Additionally, a consumer's perception may be gathered, for example, by mapping a consumer's facial response to an advertisement, for example by using an optical device operatively coupled to the device displaying the advertisement, such as an APPLE™ IBOOK™ or a netbook with a webcam. It is well established that facial responses can be correlated to emotion. See, for example, “The Role of Facial Response in the Experience of Emotion,” Journal of Personality and Social Psychology, 37(9): 1519-31, September 1979, the disclosure of which is incorporated herein by reference in its entirety. A facial expression recognition system, such as the system disclosed in U.S. Pat. No. 7,624,076 to Movellan et al., the disclosure of which is incorporated herein by reference in its entirety, may be useful for detecting a consumer's facial response to rendered content. A consumer's facial response to an advertisement, for example, neutral, anger, disgust, fear, joy, sadness, or surprise, may correlate to a user's perception of the advertisement.

Consumer 204 may also respond to the video by, for example, purchasing the advertised product from an online store server 216. The consumer may select a link in a video advertisement to purchase the product advertised, or the consumer may purchase a product from online store server 216 at another point in time.

In another example, consumer 204 may respond to the advertisement by generating user-generated content at one or more social media site servers 220. For example, the consumer 204 may post a comment about the advertisement on a social media page (e.g., FACEBOOK.COM) at the social media site server 220. As further examples, consumer 204 may generate a blog entry or comment on a blog at the social media site server 220 or may “tweet” about the comment on TWITTER.COM. User-generated content may be mined, for example using natural language processing, to determine a consumer's response to the advertisement. For example, SPSS analytics may be used to analyze consumer responses. This user-generated content may indicate a “word of mouth” response to the advertisement.

These consumer actions and responses may be tracked and aggregated by host site server 208. In one embodiment, host site server 208 receives data about consumer purchases from online store server 216 and host site server 208 crawls and indexes social media site servers 220 to identify user comments on the sites about various products. In other embodiments, an independent, third party server (not shown in FIG. 2) may collect, track and/or aggregate consumer response data. The data may be aggregated according to users based on cookies. Of course, other methods for aggregating data by consumer/client device may also be used.

While FIG. 2 shows social media site server 220, host site server 208, advertisement server 212 and online store server 216 as discrete blocks of the block diagram, one of ordinary skill in the art understands that each server may be implemented as a separate computing device, that two or more of the servers may be implemented as part of the same computing device, and that any of the servers may be implemented as a plurality of computing devices, for example a server farm, clustered servers, a cloud, etc.

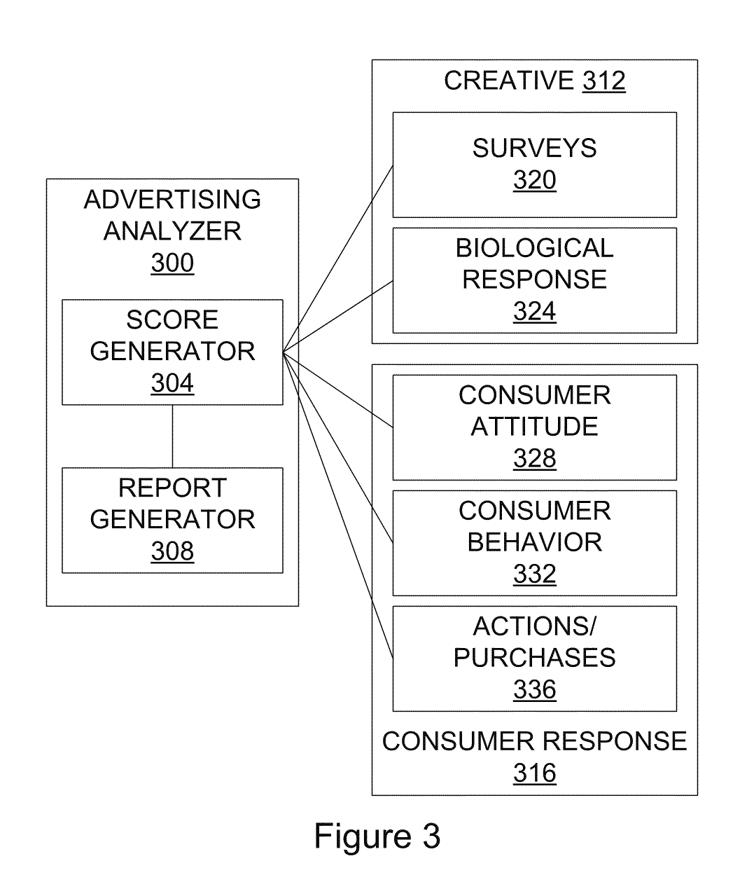

FIG. 3 illustrates an exemplary computer system, advertising analyzer 300, for determining the effectiveness of content, such as an advertising campaign. Advertising analyzer 300 includes a score generator 304 and may optionally include a report generator 308. Score generator 304 receives data collected from a creative 312 and a consumer response 316. Creative 312 data may include survey data 320 and/or a consumer's biological (e.g., neurological) response 324. Advertising analyzer 300 can collect the data or receive the data that has been collected by another party and/or device. Survey data 320 may be gathered in conventional fashion, for example by providing questions to a consumer to answer. Alternative embodiments may be interactive and have no survey component perceivable to a consumer. Consumer response 316 data may include direct and indirect consumer response information. In particular, the consumer response 316 data may include consumer attitude 328, consumer behavior 332, actions/purchases 336 and combinations thereof. Consumer response 316 data may be passively detected reflecting a consumer's response to an advertisement.

The score generator 304 may receive the data from the third party and the data may be in the form of a numerical score that characterizes the variable. Exemplary third parties that can provide the numerical scores include INNERSCOPE, VIZU, APERTURE, DATRAN, MAGID, NETBASE and the like. For example, INNERSCOPE may provide a numerical score characterizing a consumer's neurological (e.g., biometric) response to the advertisement; VIZU may provide a numerical score characterizing brand effectiveness (e.g., consumer preferences); APERTURE and/or DATRAN may provide a numerical score characterizing consumer demographics and connections between purchases; MAGID may provide a numerical score characterizing survey responses of a sample audience; and, NETBASE may provide a numerical score characterizing consumer generated content on the web (e.g., TWITTER comments, FACEBOOK comments, blog entries and/or comments, etc.). Another exemplary numerical score may be provided or generated based on the STARCH methodology. In another embodiment, the score generator 304 may first generate a numerical score for the variable(s) based on the data available, and/or categories of the variable(s), and then generate an overall index score for the advertising campaign based on the numerical scores. Of course, score generator 304 may also generate the index score using a combination of received numerical scores and generated numerical scores.

Score generator 304 may generate an index score by weighing the variables 312-336. In one embodiment, the index score is generated using a statistical analysis, for example a regression analysis. For example, a least squares regression analysis may be performed on the collected data 312-336. Of course, other types of statistical analyses may be used to generate the index score in addition to or in lieu of regression analysis. In particular, score generator 204 may be configured to weigh the variables without requiring a known variable to generate the index score.

The data collected may cross multiple advertising campaigns for a product, multiple advertising campaigns for multiple products in the same market, multiple advertising campaigns for multiple products across multiple markets, and/or multiple types of advertising campaigns (e.g., print, video, online, mobile, etc.). As more data is collected, the generation of the index score for a particular advertising campaign that is being analyzed can be improved. For example, certain variables may be added or eliminated for certain products, and/or the weighting of certain variables may be reduced or increased for certain products. The index score generation disclosed herein may be scalable and repeatable. The index score allows advertisers to estimate the return on investment (“ROI”) of advertising more accurately and using more complete information. The ROI estimate, having both a survey component and a narrow research component, may allow an advertiser to better understand what aspects of a creative message resonate with a consumer and what motivates a consumer to change their behavior in some way.

Additionally, the index score may evolve over time to more accurately estimate the ROI of advertising. Every time a new advertisement or advertisement campaign is indexed, it may be indexed against prior campaigns, thus providing more accurate weighting of certain variables. In this fashion, as data is collected on more campaigns and in turn weighting of certain variables becomes more accurate, the intelligence of the index and accuracy of estimated ROI of advertising may be increased. Advertisements or advertisement campaigns may also be indexed against, for example, the industry, a category of products, an advertiser's own brands, or a competitor's brands related to the advertiser's brands.

Report generator 308 may be configured to generate reports based on the collected data and, in particular, based on the generated index score. In one embodiment, the generated index score is presented in the report along with methodologies to improve the index score. In another embodiment, the analyzed advertising campaign is compared to other advertising campaigns based on the index score generated for each of the advertising campaigns. For example, an advertising campaign for a product can be compared with previous advertising campaigns for the same product. In another example, the advertising campaign for a product can be compared with advertising campaigns for other similar products (i.e., products in the same market). In yet another example, the advertising campaign for a product can be compared with advertising campaigns for all products.

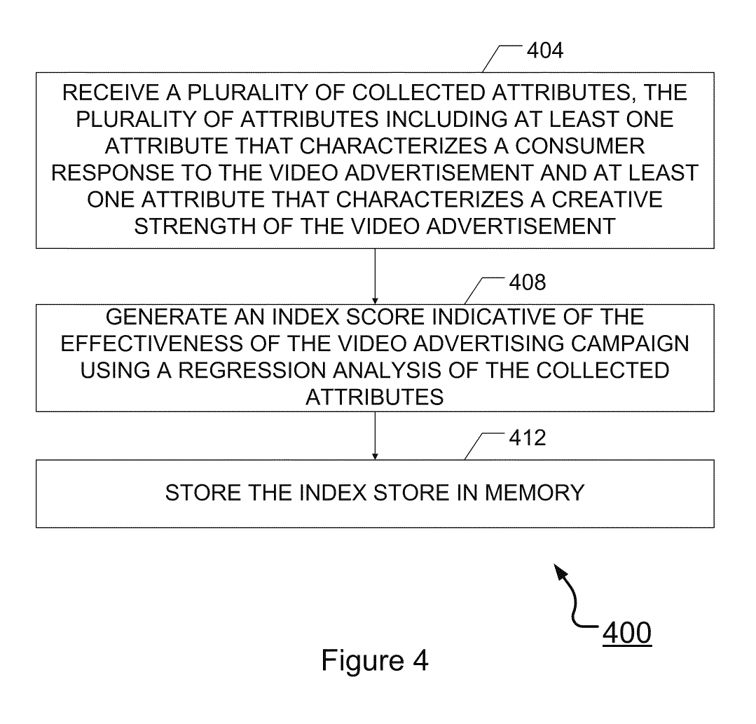

FIG. 4 illustrates an exemplary process 400 for determining effectiveness of a video advertising campaign. Of course, process 400 described below is merely exemplary and may include a fewer or greater number of steps, and the order of at least some of the steps may vary from that described below.

Process 400 begins by receiving a plurality of attributes, the plurality of attributes may include at least one attribute that characterizes a consumer response to the video advertisement and at least one attribute that characterizes a creative strength of the video advertisement (block 404). For example, consumer response data may be collected that relates to consumer attitude, consumer behavior and actions/purchases 336 towards the video advertisement. In another example, a numerical score characterizing the consumer response to the video advertisement may be collected. Similarly, creative strength data or a numerical score characterizing the creative strength of the video advertisement may be collected (e.g., using consumer surveys and/or neurological/biological responses to the video advertisements).

Process 400 continues by generating an index score indicative of the effectiveness of the video advertising campaign using a statistical analysis, such as a regression analysis, of the collected attributes (block 408) and storing the index score in memory (block 412). For example, a least squares regression analysis may be performed on the numerical scores characterizing the variables.

Process 400 may also include additional steps that are not shown. For example, process 400 may further include generating a report as described above. In another example, process 400 may include receiving a numerical score characterizing at least one of the attributes. In another example, process 400 may include generating a numerical score characterizing at least one of the attributes.

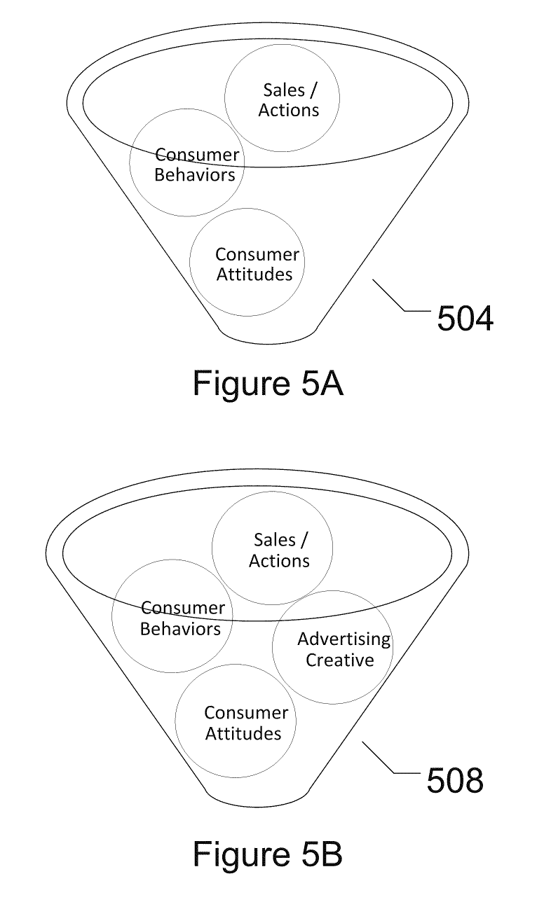

FIGS. 5A and 5B illustrate exemplary categories of data that may be used to calculate the index score. For example, FIG. 5A shows that the index score may be calculated using data from the following categories: sales/actions, consumer behaviors and consumer attitudes. In another example, FIG. 5B shows that the index score may be calculated using data from the following categories: sales/actions, consumer behaviors, consumer attitudes and advertising creative. Sales/actions category data may include, for example, click through rates (i.e., the ratio of how many users clicked on an ad versus the number of times the ad was rendered) or video consumption (i.e., how many users view a video having an advertisement displayed therein). Consumer behaviors category data may include, for example, profile and demographic information. Consumer attitudes category data may include, for example, measurement of consumer buzz, for example how a consumer comments on an advertised product in a blog. Advertising creative category data may include a user's behavior, such as whether a user purchased an advertised product.

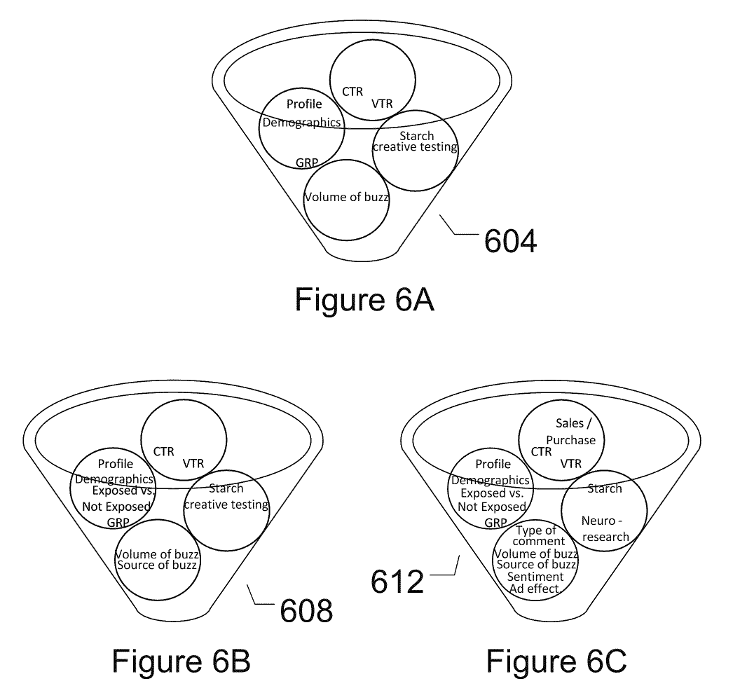

FIGS. 6A through 6C illustrate exemplary data points that may be used to calculate the index score. For example, as shown in FIG. 6A, the index score may be calculated using a click-through rate (“CTR”) and/or view-through rate (“VTR”) in the sales/actions category, profile demographics and/or gross rating point (“GRP”) in the consumer behaviors category, volume of buzz (e.g., number of comments) in the consumer attitudes category, and survey data (e.g., STARCH creative testing) in the advertising creative category.

FIG. 6B illustrates additional data types in some of the categories that may be used to calculate the index score. For example, FIG. 6B shows exposed vs. not exposed may also be considered in the consumer behaviors category and source of buzz (e.g., a social networking site vs. a blog) may also be considered in the consumer attitudes category.

FIG. 6C illustrates still more data types that may further be considered to calculate the index score. For example, in FIG. 6C, sales/purchase (i.e., whether a consumer purchased an advertised product) may also be considered in the sales/action category, type of comment (i.e., review of product or other comment on product), sentiment (i.e., whether the comment reflected positively or negatively on the product) and ad effect (i.e., how consumer actions may have been changed in response to an ad) may also be considered in the consumer attitudes category, and neuro-research (e.g., consumer sub-conscious/biological responses to advertisements) may also be considered in the advertising creative category.

An index score may be generated for each category, and an overall index score for the advertising campaign may also be generated. Alternatively, only an overall index score may be generated or only index scores for each category may be generated.

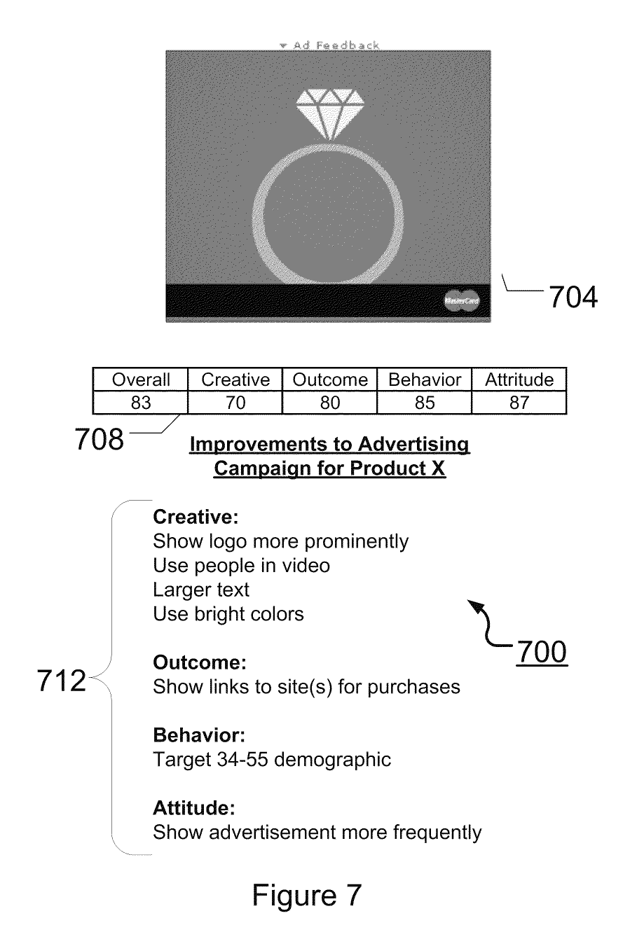

FIG. 7 illustrates an exemplary report 700 showing the effectiveness of an advertising campaign 700 including an advertisement 704. An index score 708 may be generated for advertisement 704. Index score 708 may be broken down into different categories, for example, the creative, outcome, behavior, and attribute categories described above. Report 700 may also include methodologies 712 to improve index score 708. Methodologies 712 may be determined, for example, by comparing advertising campaign 700 to prior advertising campaigns that scored high. For example, report 700 may include methodologies 712 indicating that the creative score may be increased by, for example, showing the logo more prominently if a related prior advertising campaign that scored highly showed a logo more prominently in its creative. Other methodologies 712 may indicate that the creative score could be increased by, for example, using people in the video, using larger text, and using brighter colors. In another example, the report 700 may indicate the outcome score can be improved by showing links to site(s) for purchases, the behavior score can be improved by targeting the 34-55 demographic, and the attitude score can be improved by showing the advertisement more frequently. Of course, report 700 is merely exemplary and may include more or less information. Additionally, different types of reports may be generated. For example, the report may be a comparison of the advertising campaign to other advertising campaigns based on the generated index scores, as described above.

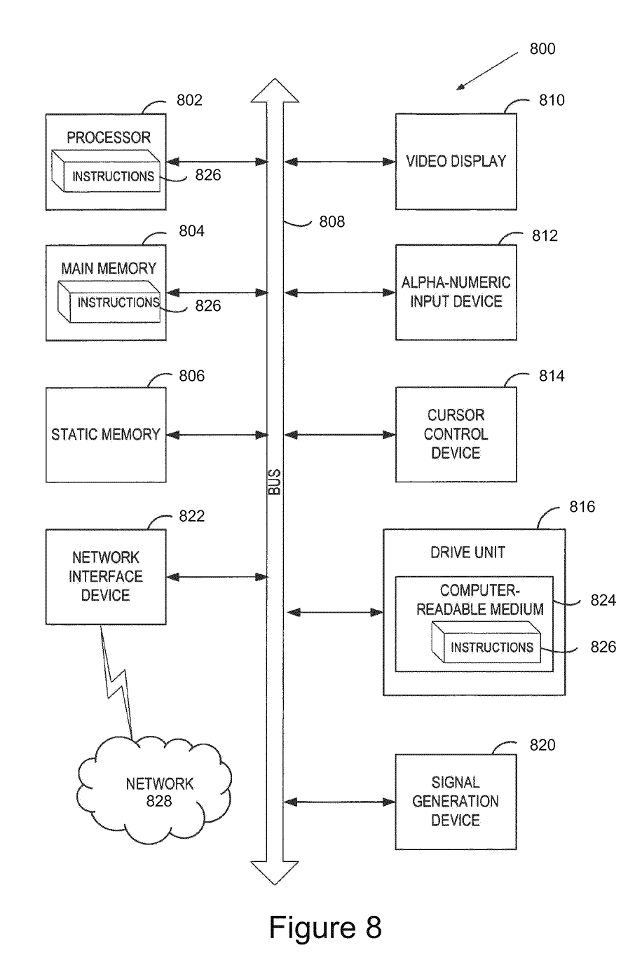

FIG. 8 shows a diagrammatic representation of a machine in the exemplary form of a computer system 800 within which a set of instructions, for causing the machine to perform any one or more of the methodologies discussed herein, may be executed. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (“PC”), a tablet PC, a set-top box (“STB”), a Personal Digital Assistant (“PDA”), a mobile telephone (e.g., a smartphone), a web appliance, a network router, switch or bridge, or any machine capable of executing a set of instructions (sequential or otherwise) that specify actions to be taken by that machine. For example, a STB may perform methodologies discussed herein for advertisements in television broadcasting. Further, while only a single machine is illustrated, the term “machine” shall also be taken to include any collection of machines that individually or jointly execute a set (or multiple sets) of instructions to perform any one or more of the methodologies discussed herein.

The exemplary computer system 800 includes a processor 802 (e.g., a central processing unit (“CPU”), a graphics processing unit (“GPU”) or both), a main memory 804 (e.g., read only memory (“ROM”), flash memory, dynamic random access memory (“DRAM”) such as synchronous DRAM (“SDRAM”) or Rambus DRAM (“RDRAM”), etc.) and a static memory 806 (e.g., flash memory, static random access memory (“SRAM”), etc.), which communicate with each other via a bus 808.

The computer system 800 may further include a video display unit 810 (e.g., a liquid crystal display (“LCD”) or a cathode ray tube (“CRT”)). The computer system 800 may also include an alphanumeric input device 812 (e.g., a keyboard), a cursor control device 814 (e.g., a mouse), a disk drive unit 816, a signal generation device 820 (e.g., a speaker) and a network interface device 822.

Disk drive unit 816 includes a tangible computer-readable medium 824 on which is stored one or more sets of non-transitory instructions (e.g., computer readable instructions 826) embodying any one or more of the methodologies or functions described herein. Instructions 826 may also reside, completely or at least partially, within main memory 804 and/or within processor 802 during execution thereof by computer system 800, main memory 804 and processor 802 also constituting computer-readable media. Instructions 826 may further be transmitted or received over a network 828 via network interface device 822.

While computer-readable medium 824 is shown to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any tangible medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, and optical and magnetic media.

It should be noted that the server is illustrated and discussed herein as having various modules which perform particular functions and interact with one another. It should be understood that these modules are merely segregated based on their function for the sake of description and represent computer hardware and/or executable instructions (e.g., software code) which may be stored on a computer-readable medium for execution on appropriate computing hardware. The various functions of the different modules and units can be combined or segregated as hardware and/or software stored on a computer-readable medium as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct a specialized apparatus to perform the method steps described herein. Embodiments have been described in relation to particular examples, which are intended in all respects to be illustrative rather than restrictive. Of course, many different combinations of hardware, software, and firmware will be suitable for practicing the embodiments. The computer devices can be PCs, handsets, servers, PDAs or any other device or combination of devices which can carry out the disclosed functions in response to computer readable instructions recorded on media. The phrase “computer system”, as used herein, therefore refers to any such device or combination of such devices.

Embodiments disclosed herein generally refer to online video advertisements, however, one of ordinary skill in the art understands that systems or processes disclosed herein may be configured to estimate the ROI of other types of content on various media. Additionally, estimated ROI of advertising campaigns on one form of media may be useful in determining a related advertising campaign on other media, for example in determining a creative, a target audience, the media of delivery, etc.

Moreover, other implementations will be apparent to those skilled in the art from consideration of the disclosure herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method for determining effectiveness of content comprising:
receiving, by a computing device, a plurality of attributes relating to rendered content, the plurality of attributes including at least one attribute that characterizes a consumer response to the rendered content and at least one attribute that characterizes a creative strength of the rendered content;
generating, by a computing device, an index score indicative of an effectiveness of the content using a statistical analysis of the collected attributes; and
storing the index score in memory.

2. The method of claim 1, wherein content is an advertisement.

3. The method of claim 2, wherein the advertisement is a video advertisement.

4. The method of claim 1, further comprising generating a report including the index score and methodologies to improve the index score.

5. The method of claim 1, further comprising receiving a numerical score characterizing at least one of the plurality of attributes, and wherein said generating step comprises generating the index score using a statistical analysis of the numerical score.

6. The method of claim 1, further comprising generating a numerical score characterizing at least one of the plurality of attributes, and wherein said generating step comprises generating the index score using a statistical analysis of the numerical score.

7. The method of claim 1, wherein the at least one attribute that characterizes a consumer response includes at least one attribute selected from the group consisting of a click through rate, a view through rate, and a gross rating point.

8. The method of claim 1, wherein the at least one attribute that characterizes a consumer response includes at least one attribute selected from the group consisting of brand effectiveness, demographics, neurological response, and user generated content.

9. The method of claim 8, wherein the at least one attribute that characterizes a consumer response includes a facial expression received by a facial expression recognition system.

10. The method of claim 1, wherein the plurality of attributes are selected from the group consisting of creative, outcome, behavior, and attitude.

11. The method of claim 1, wherein the statistical analysis includes at least one of a regression analysis, a cluster analysis, and a colinearity analysis.

12. The method of claim 1, wherein said generating step comprises generating the index score using a statistical analysis of one or more prior index scores.

13. The method of claim 12, wherein at least one prior index score is an index score generated for an industry, wherein the content relates to the industry.

14. The method of claim 12, wherein at least one prior index score is an index score generated for a category of products, wherein the content relates to the category of products.

15. The method of claim 12, wherein at least one prior index score is an index score generated for a brand, wherein the content relates to the brand.

16. The method of claim 12, wherein at least one prior index score is an index score generated for a competitor, wherein the content relates to a related product.

17. The method of claim 12, wherein said generating step includes weighting at least one of said one or more prior index scores.

18. The method of claim 1, further comprising generating, by a computing device, one or more pricing tiers for said content.

19. A computer system comprising:
a processor, configured to generate an index score indicative of efficacy of rendered content using a statistical analysis of a plurality of attributes related to the rendered content, the plurality of attributes including at least one attribute that characterizes a consumer response to the content and at least one attribute that characterizes a creative strength of the content; and
memory coupled to the processor, the memory configured to store the index score.

20. The computer system of claim 19, wherein the processor is further configured to generate a report including the index score and one or more methodologies to improve the index score.

21. The computer system of claim 19, wherein the processor is further configured to receive a numerical score characterizing at least one of the plurality of attributes, and wherein the processor generates the index score using one or more statistical analyses of the numerical score.

22. The computer system of claim 19, wherein the processor is further configured to generate a numerical score characterizing at least one of the plurality of attributes, and wherein the processor generates the index score using one or more statistical analyses of the numerical score.

23. The computer system of claim 19, wherein the plurality of attributes includes at least one attribute selected from the group consisting of a click through rate, a view through rate, and a gross rating point.

24. The computer system of claim 19, wherein the plurality of attributes includes at least one attribute selected from the group consisting of brand effectiveness, demographics, neurological response, and user generated content.

25. The computer system of claim 19, wherein the plurality of attributes are selected from the group consisting of creative, outcome, behavior, and attitude.

26. A non-transitory computer-readable storage medium having computer executable instructions stored thereon which cause a computer system to carry out a method when executed, the method comprising:
collecting a plurality of attributes, the plurality of attributes including at least one attribute that characterizes a consumer response to content and at least one attribute that characterizes a creative strength of the content;
generating an index score indicative of the effectiveness of the content using a statistical analysis of the collected attributes; and
storing the index score in a memory.

27. The computer-readable storage medium of claim 26, further comprising generating a report including the index score and methodologies to improve the index score.

28. The computer-readable storage media of claim 26, further comprising receiving a numerical score characterizing at least one of the plurality of attributes, and wherein said generating step comprises generating the index score using a statistical analysis of the numerical score.

29. The computer-readable storage media of claim 26, further comprising generating a numerical score characterizing at least one of the plurality of attributes, and wherein said generating step comprises generating the index score using a statistical analysis of the numerical score.

30. The computer-readable storage media of claim 26, wherein the plurality of attributes includes at least one attribute selected from the group consisting of a click through rate, a view through rate, and a gross rating point.

31. The computer-readable storage media of claim 26, wherein the plurality of attributes includes at least one attribute selected from the group consisting of brand effectiveness, demographics, neurological response, and user generated content.

32. The computer-readable storage media of claim 26, wherein the plurality of attributes are selected from the group consisting of creative, outcome, behavior, and attitude.
